(19) United States
(12) Patent Application Publication
(10) Pub. No.: US 2009/0149368 A1
(43) Pub. Date: Jun. 11, 2009

(54) Pellets Made of Diacyl Peroxide in a Polysaccharide Matrix

(75) Inventors: Jens Hildebrand, Aschaffenburg (DE); Stefan Leininger, Langenselbold (DE); Georg Schick, Chester, VA (US); Harald Jakob, Hasselroth (DE)

Correspondence Address: LAW OFFICE OF MICHAEL A. SANZO, LLC, 15400 CALHOUN DR., SUITE 125, ROCKVILLE, MD, 20855, US

(73) Assignee: Evonik Degussa GmbH, Essen (DE)

(21) Appl. No.: 11/991,776

(22) PCT Filed: Aug. 21, 2006
(86) PCT No.: PCT/EP2006/065504

§ 371 Date: Mar. 10, 2008

(30) Foreign Application Priority Data
Sep. 15, 2005 (DE) 10 2005 044 189.0

(51) Int. Cl. C11D 3/39

(52) U.S. Cl. 510/375; 252/186.26

(57) ABSTRACT

By introducing droplets of an aqueous suspension, in which particles of a diacyl peroxide are suspended and in which at least one polysaccharide crosslinkable by metal ions is dissolved, into a solution, which comprises metal ions crosslinking the polysaccharide, it is possible to prepare pellets which comprise particles of a diacyl peroxide embedded into a matrix. The pellets are suitable as a bleaching component in cleaning compositions.

The present invention is directed to pellets which comprise particles of a diacyl peroxide embedded into a matrix, to a process for preparing such pellets and to the use of the pellets as a bleaching component in cleaning compositions.

In cleaning compositions, especially in textile detergents, persalts such as sodium perborate or sodium percarbonate are typically used as bleaching components in combination with activators such as tetraacetylethylenediamine in order to achieve improved cleaning action with bleachable stains. With lipophilic stains, however, the bleaching action of this combination leaves something to be desired. A better bleaching action can be achieved for such stains with diacyl peroxides, especially aliphatic diacyl peroxides.

U.S. Pat. No. 4,154,695 discloses bleaches and detergents which comprise a diacyl peroxide, and the granulation of diacyl peroxides with a phlegmatizing agent for reducing the impact sensitivity.

WO 93/07086 discloses the use of clathrates of urea and a diacyl peroxide, for example dinonanoyl peroxide, as a bleaching component in detergents.

WO 97/18289 disclose dishwashing detergents in powder form or granule form, for the production of which particles which comprise a diacyl peroxide are mixed first with a dispersant in liquid form and then with the other components of the formulation. The dispersants mentioned include carboxylated polysaccharides, especially starches, celluloses and alginates.

WO 98/11189 and WO 00/27990 disclose liquid acidic textile bleaches which comprise an aliphatic diacyl peroxide, for example dilauroyl peroxide, in the form of an emulsion or microemulsion.

U.S. Pat. No. 4,515,928 discloses liquid aqueous dispersions of diacyl peroxides which comprise a surfactant as a dispersant and a polyhydric alcohol, a monosaccharide or an alkaline earth metal salt as a freezing point depressant. The optional additives mentioned for emulsifying the diacyl peroxide include vegetable gums, for example starch, gelatin, pectin and sodium alginate.

U.S. Pat. No. 6,602,837 discloses liquid alkaline detergent formulations which comprise particles of a diacyl peroxide and a chelate complexing agent. The formulations may additionally comprise a dispersant, and numerous dispersants mentioned also include carboxylated polysaccharides, more particularly alginates.

GB 1 390 503 discloses liquid or gel detergents which comprise gel capsules in which a core material is enveloped with a polymer gel. The gel capsules are produced by coextrusion with a capillary for the core material and a ring nozzle for a polymer solution; as alternatives, processes with the same effect are mentioned. Suitable materials for the polymer gel include polysaccharides, especially carrageenan, guar gum, alginic acid and amylopectin and pectins, such as low-methoxylation amido pectins and low-methoxylation citrus pectins. One possible core material mentioned is bleach, but without specifying its structure. GB 1 390 503 also teaches, on page 3 line 76 to 79, that no alginate should be used in the presence of calcium ions.

The formulations known from the prior art for cleaning compositions which comprise a diacyl peroxide have a storage stability which is still insufficient in practice when they contain alkaline-reacting and/or oxidation-sensitive components which can react with the diacyl peroxide. There is therefore a need to formulate diacyl peroxides in a form which can be produced and stored reliably and which can be used in cleaning composition formulations without there being any such undesired reactions with components of the cleaning composition formulations.

The invention provides pellets comprising a matrix of at least one polysaccharide crosslinked by metal ions and particles of a diacyl peroxide embedded into the matrix.

The invention also provides a process for preparing such pellets, comprising the steps of
a) preparing an aqueous suspension in which particles of a diacyl peroxide are suspended and in which at least one polysaccharide crosslinkable by metal ions is dissolved and
b) introducing droplets of the suspension a) into a solution which comprises metal ions crosslinking the polysaccharide.

The invention also provides cleaning compositions which comprise pellets according to the invention and at least one anionic and/or nonionic surfactant.

Pellets according to the invention comprise a matrix of at least one polysaccharide crosslinked by metal ions. The term “matrix” refers to a solid phase which surrounds the particles of a diacyl peroxide embedded therein and which, in an aqueous medium, in the case of partial or complete exchange of the crosslinking metal ions for noncrosslinking metal ions, goes into solution to such an extent that the particles of the diacyl peroxide embedded into the matrix are released.

Suitable polysaccharides for the matrix include all water-soluble polysaccharides which can be crosslinked by metal ions to give a water-insoluble gel. Preference is given to polysaccharides which contain carboxylic acid groups, and pectins, alginated and carrageenans are preferred. Pectins, alginates and carrageenans crosslinkable by metal ions are known to those skilled in the art from Ullmann's Encyclopedia of Industrial Chemistry Vol. A25, pages 24-45.

In a particularly preferred embodiment, the polysaccharide is a pectin having a degree of methoxylation of less than 50 mol % or an alginate, and the crosslinking metal ions are calcium ions.

In another particularly preferred embodiment, the polysaccharide is a carrageenan and the crosslinking metal ions are potassium ions.

The matrix of the pellets of the invention comprises preferably more than 50% by weight of polysaccharide crosslinked by metal ions and more preferably more than 80% by weight. In addition to the polysaccharide crosslinked by metal ions, the matrix of the pellets of the invention may also comprise further components, for example disintegrants.

Suitable disintegrants are all substances known to those skilled in the art which, on contact of the pellets of the invention with an aqueous medium, promote the release of the particles of diacyl peroxide embedded into the matrix. A suitable disintegrant is, for example, a mixture of sodium hydrogencarbonate and citric acid.

The pellets of the invention also comprise particles of a diacyl peroxide embedded into the matrix. Diacyl peroxides are compounds of the general formula R¹—C(O)OOC(O)—R², in which R¹ and R² are each an organic radical. The pellets of the invention preferably comprise particles of an aliphatic diacyl peroxide for which R¹ and R² are each independently alkyl groups having from 8 to 20 carbon atoms. The particles of the diacyl peroxide preferably exhibit a melting point of more than 40° C. The pellets of the invention more preferably comprise embedded particles of di-n-decanoyl peroxide (R=n-nonyl), di-n-undecanoyl peroxide (R=n-decyl) or dilauroyl peroxide (R=n-undecyl).

The particles of the diacyl peroxide embedded into the matrix preferably have a mass-based mean particle size d₅₀ in the range from 5 to 100 μm and more preferably in the range from 10 to 50 μm. By selecting the particle size within this range, firstly, good storage stability of the pellets of the invention is achieved and, secondly, a large surface area of the particles released is ensured on release of the diacyl peroxide from the matrix of the pellets, which achieves rapid bleaching action.

The proportion of the particles of diacyl peroxide embedded into the matrix in the pellets of the invention is preferably in the range from 30 to 97% by weight, especially from 60 to 90% by weight. In this range, firstly, complete enveloping of the particles of the diacyl peroxide by the matrix and hence a good storage stability is ensured, and, secondly, a high proportion of bleaching-active components in the pellets is achieved.

The pellets of the invention preferably have a spherical shape. The size of the pellets of the invention can be selected within a wide range. For use in solid granular cleaning compositions, the pellets of the invention preferably have a mass-based mean particle size d₅₀ in the range from 0.4 to 2 mm, the proportion of pellets having a diameter of smaller than 0.2 mm more preferably being less than 10% by weight. For use in liquid or gel cleaning compositions, the pellets of the invention preferably have a mean particle size d₅₀ in the range from 0.1 to 1.2 mm, more preferably from 0.3 to 0.8 mm.

The pellets of the invention have the advantage that they are storage-stable and, in the course of storage, lose active oxygen only slowly and have a low caking tendency. The pellets of the invention also exhibit a high storage stability in cleaning composition formulations, especially in formulations which comprise components with alkaline action.

The process according to the invention for preparing the pellets of the invention comprises at least two steps, the first step comprising preparation of an aqueous suspension in which particles of a diacyl peroxide are suspended and in which at least one polysaccharide crosslinkable by metal ions is dissolved, and a second step comprising introduction of droplets of the suspension formed in the first step into a solution which comprises metal ions which crosslink the polysaccharides.

For the preparation of the aqueous suspension in the first step, preference is given to using the polysaccharides and the particles of diacyl peroxide which have already been listed above as preferred for the pellets of the invention.

The proportion of the polysaccharide in the aqueous suspension is preferably within the range from 0.5 to 5% by weight, more preferably from 1 to 2% by weight. The proportion of the particles of the diacyl peroxide in the aqueous suspension is preferably in the range from 1 to 15% by weight, more preferably from 6 to 12% by weight.

The aqueous suspension prepared in the first step preferably additionally comprises a dispersant which slows or prevents the sedimentation of the particles of the diacyl peroxide. The proportion of the dispersant in the aqueous suspension is preferably in the range from 0.1 to 5% by weight. Suitable dispersants for diacyl peroxides are known to those skilled in the art, for example from U.S. Pat. No. 3,988,261, column 10 line 8 to column 12 line 53.

In the first step, the aqueous suspension is prepared preferably by mixing an aqueous suspension of the diacyl peroxide with an aqueous solution of the polysaccharide crosslinkable by metal ions. Aqueous suspensions of diacyl peroxides are commercially available, for example dilauroyl peroxide as a 40% by weight suspension under the trade name LP-40-SAQ from Degussa.

In the second step of the process according to the invention, droplets of the suspension prepared in the first step are introduced into a solution which comprises metal ions which crosslink the polysaccharide. The concentration of the metal ions in this solution is selected such that the polysaccharide which is dissolved in the suspension from the first step is crosslinked by the metal ions to give a water-insoluble gel. The concentration of the metal ions in the solution used in the second step is preferably within the range from 0.01 to 1 mol per liter, more preferably from 0.05 to 0.5 mol per liter.

Upon introduction of the droplets of the suspension from the first step into the solution comprising crosslinking metal ions, a skin of crosslinked polysaccharide gel initially forms around each of the droplets introduced. The droplets thus enveloped subsequently harden as a result of diffusion of metal ions into the interior of the droplets to give the pellets of the invention.

The solution used in the second step of the process comprises the crosslinking metal ions preferably in the form of the chloride salts, especially calcium ions in the form of calcium chloride, or potassium ions in the form of potassium chloride.

The introduction of droplets of the suspension prepared in the first process step into the solution which comprises metal ions which crosslink the polysaccharide can be carried out by any method known to those skilled in the art for introducing droplets. In a preferred embodiment of the process, the droplets of the suspension are introduced into the solution comprising metal ions by means of one or more vibrating nozzles, the amplitude and frequency of the vibration being selected such that drops of uniform size form. This embodiment of the process allows to prepare pellets of the invention with a narrow particle size distribution.

The pellets obtained in the second step of the process according to the invention are preferably separated from the liquid phase in a subsequent step and then dried. For the removal of the pellets from the liquid phase and the subsequent drying, all solid/liquid separation processes and drying processes known to those skilled in the art may be used. The pellets can be removed from the liquid phase, for example, by filtration, decanting or centrifugation. The pellets can be dried by preferably vacuum drying, fluidized bed drying in an air stream or by suspending the particles in a water-removing solvent, preferably methanol, ethanol or isopropanol. The drying is effected preferably down to a water content of less than 50% by weight, more preferably less than 20% by weight.

Preferably the drying occurs at a temperature of the pellets in the range from 0 to 50° C. To dry the pellets, it is also possible to employ temperatures above the melting point of the diacyl peroxide embedded into the matrix, without there being any caking of the pellets.

The process according to the invention can be performed particularly reliably since the diacyl peroxide need not be handled in pure form, more particularly not at elevated temperature, as is the case in processes in which a melt of the diacyl peroxide is processed. The process according to the invention also allows pellets to be prepared with a narrow particle size distribution, which do not tend to segregate in granular cleaning composition formulations.

The pellets of the invention can be used advantageously as a bleaching component in cleaning compositions. Cleaning compositions in the context of the invention are all formulations which comprise at least one anionic and/or nonionic surfactant and are suitable for cleaning surfaces in combination with water. A form of cleaning compositions which is preferred in the context of the invention is that of detergents which are suitable for cleaning textiles in an aqueous wash liquor. A further form of cleaning compositions which is preferred in the context of the invention is that of machine dishwasher detergents which are suitable for machine cleaning of dishware and cutlery.

The invention further provides cleaning compositions which comprise pellets according to the invention. The cleaning compositions of the invention comprise the pellets of the invention preferably in an amount of from 1 to 40% by weight based on the total amount of the cleaning composition.

The cleaning compositions of the invention may feature a solid form and may then, besides the pellets of the invention, also comprise further components in the form of powders or in the form of granules. They may additionally also include press shaped bodies, in which case the pellets of the invention may be part of the press shaped bodies. Such press shaped bodies in the form of extrudates, pellets, briquettes or tablets may be produced by processes of press agglomeration, especially by extrusion, strand pressing, punch pressing, roller compaction or tableting. The cleaning compositions of the invention may additionally comprise a binder for carrying out the press agglomeration, which imparts a higher hardness to the shaped bodies in the course of press agglomeration. However, for cleaning compositions of the invention comprising press shaped bodies it is preferred not to use any additional binder and one of the wash-active components, for example a nonionic surfactant, fulfills the function of the binder.

The cleaning composition of the invention may additionally also feature a liquid form or gel form and comprise the pellets of the invention dispersed in a liquid phase or a gel phase. In addition to the pellets of the invention, further particles may be dispersed in the liquid phase or the gel phase. The rheological properties of the liquid phase or of the gel phase are preferably adjusted such that the particles dispersed therein remain suspended and do not settle out during storage. The composition of a liquid phase is therefore preferably selected such that it has thixotropic or pseudoplastic flow properties. To establish such flow properties, it is possible to add suspending auxiliaries such as swelling clays, especially montmorillonites, precipitated and pyrogenic silicas, vegetable gums, especially xanthans, and polymeric gelling agents such as vinyl polymers containing carboxyl groups.

Cleaning compositions according to the invention in liquid form or gel form which contain more than 5% by weight of water preferably additionally also comprise, in dissolved form, metal ions in a concentration which leads to crosslinking of the polysaccharide present in the pellets of the invention. The concentration of the metal ions in the liquid or gel cleaning composition is preferably selected such that, in the case of use of the cleaning composition as intended, dilution with water achieves a concentration of the metal ions which is sufficiently low that the polysaccharide, owing to the relatively low degree of crosslinking, goes into solution and releases the embedded particles of the diacyl peroxides.

The cleaning composition of the invention may also comprise, besides the pellets of the invention and at least one anionic and/or nonionic surfactant, as further components for example cationic surfactants, builders, alkaline components, persalts, bleach activators, enzymes, chelating complexing agents, graying inhibitors, foam inhibitors, optical brighteners, fragrances and dyes.

Suitable anionic surfactants are, for example, surfactants having sulfonate groups, preferably alkylbenzenesulfonates, alkanesulfonates, alpha-olefinsulfonates, alpha-sulfo fatty acid esters or sulfosuccinates. In the case of alkylbenzenesulfonates, preference is given to those having a straight-chain or branched alkyl group having from 8 to 20 carbon atoms, especially having from 10 to 16 carbon atoms. Preferred alkanesulfonates are those having straight alkyl chains having from 12 to 18 carbon atoms. In the case of alpha-olefinsulfonates, preference is given to using the reaction products of the sulfonation of alpha-olefins having from 12 to 18 carbon atoms. Among the alpha-sulfo fatty acid esters, preference is given to sulfonation products of fatty acid esters formed from fatty acids having from 12 to 18 carbon atoms and short-chain alcohols having from 1 to 3 carbon atoms. Suitable anionic surfactants are also surfactants having a sulfate group in the molecule, preferably alkyl sulfates and ether sulfates.

Preferred alkyl sulfates are those having straight-chain alkyl radicals having from 12 to 18 carbon atoms. Also suitable are beta-branched alkyl sulfates, and alkyl sulfates singly or multiply alkyl-substituted in the middle of the longest alkyl chain. Preferred ether sulfates are the alkyl ether sulfates, which are obtained by ethoxylating linear alcohols having from 12 to 18 carbon atoms with from 2 to 6 ethylene oxide units and subsequent sulfation. The anionic surfactants used may finally also be soaps, such as for example alkali metal salts of lauric acid, myristic acid, palmitic acid, stearic acid and/or natural fatty acid mixtures, for example coconut fatty acids, palm kernel fatty acids or tallow fatty acids.

Suitable nonionic surfactants are, for example, alkoxylated compounds, especially ethoxylated and propoxylated compounds. Particularly suitable compounds are condensation products of alkylphenols or fatty alcohols with from 1 to 50 mol, preferably from 1 to 10 mol, of ethylene oxide and/or propylene oxide. Likewise suitable are polyhydroxy fatty acid amides in which an organic radical having one or more hydroxyl groups, which may also be alkoxylated, is bonded to the amide nitrogen. Likewise suitable as nonionic surfactants are alkylglycosides having a straight-chain or branched alkyl group having from 8 to 22 carbon atoms, especially having from 12 to 18 carbon atoms, and a mono- or diglycoside radical, which is preferably derived from glucose.

Suitable cationic surfactants are, for example, mono- and dialkoxylated quaternary amines having a C₆- to C₁₈-alkyl radical bonded to the nitrogen and one or two hydroxyalkyl groups.

The cleaning compositions of the invention may further comprise builders which are capable of binding calcium and magnesium ions dissolved in water in the course of use. Suitable builders are alkali metal phosphates and alkali metal polyphosphates, especially pentasodiumtriphosphate; water-soluble and water-insoluble sodium silicates, especially sheet silicates of the formula Na₅Si₂O₅; zeolites of structures A, X and/or P; and also trisodium citrate. In addition to the builders, it is also possible to use organic cobuilders, for example polyacrylic acid, polyaspartic acid and/or acrylic acid copolymers with methacrylic acid, acrolein or sulfonic acid-containing vinyl monomers, and their alkali metal salts.

The cleaning compositions of the invention may also comprise alkaline components which when used as intended bring about a pH in the range from 8 to 12 in the aqueous cleaning composition solution. Suitable alkaline components are in particular sodium carbonate, sodium sesquicarbonate, sodium metasilicate and other soluble alkali metal silicates.

The cleaning compositions of the invention may, in addition to the pellets of the invention, also comprise persalts, for example alkali metal perborates, alkali metal carbonate perhydrates, alkali metal persilicates, alkali metal persulfates, alkali metal peroxophosphates and alkali metal peroxopyrophosphates, from which hydrogen peroxide is released in an aqueous medium. Preferred persalts are sodium perborate tetrahydrate, sodium perborate monohydrate and sodium carbonate perhydrate. Particular preference is given to sodium carbonate perhydrate. Suitable sodium carbonate perhydrate for use in liquid detergents is known from WO 2004/056955. By combining the pellets of the invention comprising a diacyl peroxide with a persalt which releases hydrogen peroxide, a synergistic bleaching action is achieved, which goes beyond the action of the individual components, especially when the cleaning composition comprises alkaline components. The synergistic action is presumably based on a reaction between the diacyl peroxide of the structure R—C(O)OOC(O)—R with hydrogen peroxide to give two molecules of percarboxylic acid of the structure R—C(O)OOH, which presumably proceeds by attack of the hydroperoxide anion HOO⁻ on the diacyl peroxide.

Suitable bleach activators for the cleaning composition of the invention are in particular compounds having one or more perhydrolyzable acyl groups bonded to nitrogen or to oxygen, which react with the hydrogen peroxide released from the sodium percarbonate particles in the aqueous cleaning composition solution to give peroxycarboxylic acids. Examples of such compounds are polyacylated alkylenediamines, such as especially tetraacetylethylenediamine (TAED); acylated triazine derivatives, especially 1,5-diacetyl-2,4-dioxohexahydro-1,3,5-triazine (DADHT); acylated glycolurils, especially tetraacetylglycoluril (TAGU); N-acylamides, especially N-nonanoylsuccinimide (NOSI); acylated phenolsulfonates, especially n-nonanoyl- or isononanoyloxybenzenesulfonate (n- or iso-NOBS); carboxylic anhydrides such as phthalic anhydride; acylated polyhydric alcohols such as ethylene glycol diacetate, 2,5-diacetoxy-2,5-dihydrofuran, acetylated sorbitol and mannitol and acetylated sugars such as pentaacetylglucose; enol esters; and n-acylated lactams, especially N-acylcaprolactams and N-acylvalerolactams. Likewise suitable as bleach activators are amino-functionalized nitriles and salts thereof (nitrile quats), which are known, for example, from the journal Tenside Surf. Det. 1997, 34(6), pages 404-409. The bleach activators used may also be transition metal complexes which can activate hydrogen peroxide for bleaching stain removal. Suitable transition metal complexes are, for example, known from EP-A 0 544 490 page 2 line 4 to page 3 line 57; WO 00/52124 page 5 line 9 to page 8 line 7 and page 8 line 19 to page 11 line 14; WO 04/039932 page 2 line 25 to page 10 line 21; WO 00/12808 page 6 line 29 to page 33 line 29; WO 00/60043 page 6 line 9 to page 17 line 22; WO 00/27975 page 2 lines 1 to 18 and page 3 line 7 to page 4 line 6; WO 01/05925 page 1 line 28 to page 3 line 14; WO 99/64156 page 2 line 25 to page 9 line 18; and GB-A 2 309 976 page 3 line 1 to page 8 line 32.

The cleaning compositions of the invention may further comprise enzymes which enhance the cleaning action, especially lipases, cutinases, amylases, neutral and alkaline proteases, esterases, cellulases, pectinases, lactases and/or peroxidases. The enzymes may be adsorbed on carrier substances or be embedded into coating substances in order to protect them from decomposition.

The cleaning compositions of the invention may also comprise chelating complexing agents for transition metals, with which catalytic decomposition of active oxygen compounds in the wash liquor or the aqueous cleaning composition solution can be prevented, and the dissolution of the polysaccharide matrix of the pellets of the invention can be accelerated by complexation of the crosslinking metal ions. Suitable are for example phosphonates such as hydroxyethane-1,1-diphosphonate, nitrilotrimethylenephosphonate, diethylenetriaminepenta(methylenephosphonate), ethylenediaminetetra(methylenephosphonate), hexamethylenediaminetetra(methylenephosphonate) and their alkali metal salts. Likewise suitable are nitrilotriacetic acid and polyaminocarboxylic acids, such as especially ethylenediaminetetraacetic acid, diethylenetriaminepentaacetic acid, ethylenediamine-N,N′-disuccinic acid, methylglycinediacetic acid and polyaspartates, and their alkali metal and ammonium salts. Finally, polybasic carboxylic acids and especially hydroxycarboxylic acids, such as especially tartaric acid and citric acid, are also suitable as chelating complexing agents.

Cleaning compositions according to the invention may additionally comprise redeposition inhibitors which keep the detached soil suspended and prevent reattachment of the soil to the cleaned surface. Suitable redeposition inhibitors are, for example, cellulose ethers such as carboxymethylcellulose and its alkali metal salts, methylcellulose, hydroxyethylcellulose and hydroxypropylcellulose. Polyvinylpyrrolidone is likewise suitable.

The cleaning compositions of the invention may further also comprise foam inhibitors which reduce foam formation in the aqueous cleaning solution. Suitable foam inhibitors are, for example, organopolysiloxanes such as polydimethylsiloxane, paraffins and/or waxes, and mixtures thereof with fine particulate silicas.

Cleaning compositions according to the invention may optionally comprise optical brighteners which attach to the fiber, absorb light in the UV range and fluoresce in a blue color in order to compensate yellowing of the fiber. Suitable optical brighteners are, for example, derivatives of diaminostilbenedisulfonic acid such as alkali metal salts of 4,4′-bis(2-anilino-4-morpholino-1,3,5-triazinyl-6-amino)stilbene-2,2′-disulfonic acid or substituted diphenylstyryls such as alkali metal salts of 4,4′-bis(2-sulfostyryl)diphenyl.

The cleaning compositions of the invention may finally also comprise fragrances and dyes.

The cleaning compositions of the invention in liquid form or gel form may additionally also contain up to 30% by weight of organic solvents, for example methanol, ethanol, n-propanol, isopropanol, n-butanol, ethylene glycol, 1,2-propylene glycol, 1,3-propylene glycol, 1,4-butylene glycol, glycerol, diethylene glycol, ethylene glycol methyl ether, ethanolamine, diethanolamine and/or triethanolamine.

Compared to cleaning compositions, which comprise particles of diacyl peroxides not according to the invention, the cleaning compositions of the invention exhibit better storage stability with lower losses of active oxygen content in the course of storage, especially for cleaning compositions which comprise alkaline components. At the same time, there is reduced oxidative attack on oxidation-sensitive components of the cleaning composition, for example enzymes, optical brighteners, fragrances and dyes.

A preferred embodiment of the cleaning compositions of the invention is that of machine dishwasher detergents in the form of tablets, said tablets also comprising a silver anticorrosive as well as the pellets of the invention. Silver anticorrosives in the context of the invention are agents which prevent or reduce the tarnishing of non-ferrous metals, especially of silver, during machine cleaning with the machine dishwasher detergent. The silver anticorrosives used are preferably one or more compounds from the group of the triazoles, benzotriazoles, bisbenzotriazoles, aminotriazoles and alkylaminotriazoles. The compounds of the substance classes mentioned may also have substituents, for example linear or branched alkyl groups having from 1 to 20 carbon atoms, as well as vinyl, hydroxyl, thiol or halogen radicals. In the case of bisbenzotriazoles, preference is given to compounds in which the two benzotriazole groups are each bonded in the 6 position via an X group, in which X may be a bond, a straight-chain alkylene group which is optionally substituted by one or more C₁- to C₄-alkyl groups and has preferably from 1 to 6 carbon atoms, a cycloalkyl radical having at least 5 carbon atoms, a carbonyl group, a sulfonyl group, an oxygen atom or a sulfur atom. A particularly preferred silver corrosion protectant is tolyltriazole.

Machine dishwasher detergents according to the invention, which comprise a silver anticorrosive and are in the form of tablets, exhibit significantly lower yellowing of the tablets during the storage of the machine dishwasher detergent, compared to machine dishwasher detergents in which the diacyl peroxide is not embedded into a matrix of a polysaccharide.

### EXAMPLES

### Example 1

25 parts by weight of a 40% by weight aqueous suspension of dilauroyl peroxide were mixed with 75 parts by weight of a 2.5% by weight aqueous solution of sodium alginate. The resulting suspension was added dropwise to a stirred 0.1 M aqueous solution of calcium chloride through a vibrating nozzle of diameter 0.5 mm with a flow rate of 0.21 g/s at a vibration frequency of 410 Hz. Thereafter, the resulting spherical pellets were filtered off and dried at 30° C. under reduced pressure for 48 h.

The resulting pellets were virtually insoluble in deionized water at 20° C. and exhibited no noticeable change within 4 h. In a 0.1 M solution of EDTA, in contrast, the pellets dissolved within 5 min with release of the dialauroyl peroxide particles in the form of a suspension.

The storage stability of the pellets was determined by microcalorimetry determination of the energy release in the course of storage at 40° C. with a TAM® Thermal Activity Monitor from thermometric AB, Järfälla (Sweden), and the TAM value was determined as the measurement after 48 h. The resulting pellets exhibited a TAM value of 2.3 μW/g. A peroxygen compound is sufficiently storage-stable when the TAM value for the energy release after 48 h is not more than 10 μW/g.

1-11. (canceled)

12. Pellets comprising:
a) a matrix comprising at least one polysaccharide crosslinked by metal ions; and
b) particles of a diacyl peroxide embedded in said matrix.

13. The pellets of claim 12, wherein said polysaccharide is selected from the group consisting of: pectins; alginates; carrageenans; and mixtures thereof.

14. The pellets of claim 13, wherein said metal ions are calcium ions and said polysaccharide is either a pectin having a degree of methoxylation of less than 15 mol % or an alginate.

15. The pellets of claim 13, wherein said metal ions are potassium ions and said polysaccharide is a carrageenan.

16. The pellets of claim 12, wherein said diacyl peroxide comprises acyl radicals R—C(O) in which R is an alkyl group having from 8 to 20 carbon atoms.

17. The pellets of claim 16, wherein R is a n-nonyl, n-decyl or n-undecyl alkyl group.

18. A process for producing the pellets of claim 12, comprising the steps of:
a) preparing an aqueous suspension in which particles of a diacyl peroxide are suspended and in which at least one polysaccharide crosslinkable by metal ions is dissolved; and
b) introducing droplets of the suspension of step a) into a solution which comprises metal ions crosslinking the polysaccharide.

19. The process of claim 18, wherein said suspension additionally comprises a dispersant.

20. The process as claimed in claim 18, wherein an aqueous suspension of a diacyl peroxide is mixed in step a) with an aqueous solution of the polysaccharide crosslinkable by a metal ion.

21. The process of claim 18, wherein the pellets obtained in step b) are separated from the liquid phase and then dried.

22. The process of claim 21, wherein said suspension additionally comprises a dispersant.

23. The process of claim 21, wherein an aqueous suspension of a diacyl peroxide is mixed in step a) with an aqueous solution of the polysaccharide crosslinkable by a metal ion.

24. A cleaning composition comprising the pellets of claim 12 and at least one anionic and/or nonionic surfactant.

25. The cleaning composition of claim 24, wherein the polysaccharide in said pellets is selected from the group consisting of: pectins; alginates; carrageenans; and mixtures thereof.

26. The cleaning composition of claim 25, wherein the metal ions in said pellets are calcium ions and said the polysaccharide in said pellets is either a pectin having a degree of methoxylation of less than 15 mol % or an alginate.

27. The cleaning composition of claim 25, wherein the metal ions in said pellets are potassium ions.

28. The cleaning composition of claim 27, wherein the polysaccharide in said pellets is a carrageenan.

29. The cleaning composition of claim 24, wherein the diacyl peroxide in said pellets comprises acyl radicals R—C(O) in which R is an alkyl group having from 8 to 20 carbon atoms.

30. The cleaning composition of claim 29, further comprising a persalt selected from the group consisting of: sodium perborate tetrahydrate, sodium perborate monohydrate and sodium carbonate perhydrate.

31. The cleaning composition of claim 30, wherein said persalt is sodium carbonate perhydrate.
